(19) United States
(12) Patent Application Publication
(10) Pub. No.: US 2014/0253453 A1
(43) Pub. Date: Sep. 11, 2014

(54) Computer Display Object Controller

(71) Applicant: Jack Lo, Pacifica, CA (US)

(72) Inventor: Jack Lo, Pacifica, CA (US)

(21) Appl. No.: 13/792,045

(22) Filed: Mar. 9, 2013

(51) Int. Cl. G06F 3/023

(52) U.S. Cl. CPC G06F 3/0233
USPC 345/168

(57) ABSTRACT

A display object controller includes a sensor elevated above the keys of a keyboard. The sensor is directed to view and monitor a user's first hand in a typing position on the keyboard. The controller includes a switch positioned adjacent the spacebar of the keyboard. The sensor and switch are connected to a processor which is connected to a computer system. The switch is arranged to enable or disable display object control. When the switch is engaged by the thumb of the user's second hand, the processor is responsive to the sensor to track hand motion for controlling display objects. When the switch is disengaged by the thumb, the processor communicates with the computer system to disable tracking hand motion so the fingers may type on the keyboard without controlling the display objects. In another embodiment, a switching means is provided in software, wherein the sensor is arranged to detect the second hand performing or ceasing to perform a predetermined gesture as a command to enable or disable display object control mode.

### BACKGROUND OF THE INVENTION

1. Field of the Invention

The invention broadly relates to computer input devices, and more specifically to a hand motion input device.

2. Prior Art

There are many types of computer input devices for controlling objects such as icons and pointers on a display. Each has its advantages and disadvantages. The most common pointing device for desktop computers is the mouse. It includes a housing shaped for being grasped by a hand and moved in two dimensions on a desk. A sensor on the bottom of the mouse detects sliding movement across the desk surface or mouse pad to control the pointer. Buttons on the housing enable clicking display objects. The mouse is very precise and easy to control with small movements, but since it is separate from the keyboard, it requires the hand to frequently move away from the keyboard. The movement away from the keyboard is not only inconvenient, it requires the fingers to find the home keys on the keyboard again after using the mouse. Some users develop repetitive stress disorders using mouses due to the twisted arm position required by most mice.

A touch pad comprises a flat panel that senses touch by one or more fingers and translates the motion into display object control inputs. It is typically built into a notebook computer in front of the spacebar. Since uses typically use the index finger to operate the touch pad, it requires the hand to move a short distance away from the keys on the keyboard to operate. The movement away from the keyboard is not only inconvenient, it requires the fingers to find the home keys on the keyboard again after using the touch pad. Further, touch pads have less accuracy and speed than mice, which makes pointer control more difficult. A mechanical switch under the touchpad performs a click when the touchpad is pressed downward a short distance, but the actuating force is relatively high and uncomfortable. Therefore touch pad drivers or software are arranged to interpret a finger lifting and quickly pressing down again as a click. Since this tapping motion requires lifting a finger and pressing down against the touch pad again, it is not as intuitive or convenient as simply pressing down to click.

Some touch pads have numeric keys printed on them so that they may be either used as a touch pad or as a touch sensitive numeric keyboard, but not both functions at the same time. There is a key dedicated to changing the device between touch pad and keyboard modes. A serious disadvantage is that in keyboard mode, the keys are touch keys. Finding the correct keys by touch is not only difficult, the touch sensitive keys have no key travel and therefore no mechanical feedback. If the keyboard is calibrated to allow the fingers to lightly rest on them without unintentional activation, it must have a relatively high operating force threshold that makes typing uncomfortable. If the keyboard is calibrated to be activated by light touch, the fingers cannot rest on them like they do on the home keys of a conventional keyboard.

A roller bar pointing device comprises a transverse housing for being positioned in front of a keyboard. A cylindrical roller bar extends along the housing parallel to the spacebar on the keyboard. The roller bar may be rolled for Y direction pointer movement, and slid from side to side for X direction pointer movement. The bar may be pressed down to operate a mechanical switch for performing a click on display. But the hand must move away from the typing position to operate the roller bar with the fingers. The small diameter bar is uncomfortable to press to click, and mentally translating the rolling and sliding motion into 2 dimensional pointer movements is unintuitive. Further, the device is very large and takes up a lot of desk space.

A motion controller senses arm or finger motion and translates it into computer or game console input for controlling pointer movement and other functions. The KINECT by Microsoft in Redmond, Wash., is a game console motion controller. It includes forward facing sensors in a housing on a pedestal for being positioned on the edge of a desk or TV stand. During operation, the housing tilts up and down automatically to find the floor and see the users in the play space. Since it can only sense large arm movements, it is not suitable for controlling a pointing device in a desktop or notebook computer.

A motion controller designed for fine control is the LEAP MOTION CONTROLLER by Leap Motion in San Francisco, Calif. It includes a rectangular housing for being positioned in front of a computer monitor. An upward facing sensor on the top of the housing is arranged to detect hand and finger movements above the controller. The LEAP MOTION CONTROLLER is sensitive enough to detect even small finger movements for precise pointer control. The LEAP MOTION CONTROLLER has a field of view directed upward and away from the keyboard. It requires the arm and hand to be moved away from the keyboard and raised up and forward into its field of view, but raising the arm frequently all day long is tiring.

Prior art pointing devices or motion controllers each has some advantages and some disadvantages that make their use inconvenient when repeated many times per day, or cause discomfort and even injury over the long term.

### BRIEF SUMMARY OF THE INVENTION

Therefore an objective of the invention is to provide a controller for controlling computer display objects with hand movements in the air while substantially keeping the arms substantially in their typing positions relative to a keyboard. It overcomes the primary drawback of prior art mice and touch pads by eliminating having to move the hand a substantial distance from its typing position to grab a mouse or operate a touch pad. It overcomes the primary drawback of prior art combination touch pad and touch sensitive keyboards by operating over a mechanical keyboard. It overcomes the primary drawback of prior art roller bar pointing devices by eliminating having to move the hand away from its typing position. It overcomes the primary drawback of prior art motion controllers by eliminating having to raise the arm high up from the typing position. It achieves these objectives and advantage with a sensor elevated above the keys of a mechanical keyboard. The sensor is directed to view and monitor a user's first and second hands in typing positions on the keyboard. The controller includes a switch positioned adjacent the spacebar of the keyboard. The sensor and switch are connected to a processor which is connected to a computer system. When the switch is engaged by the thumb of the user's second hand, the processor is responsive to the sensor to track the first hand's motions in the air, directly over and in close proximity to the keyboard for controlling display objects. There is no need to raise the arms up from their typing positions. When the switch is disengaged by the thumb, the processor communicates with the computer system to disable motion tracking so the fingers may type on the keyboard without controlling display objects. In another embodiment, switching between display object control mode and typing mode may be performed by software, without a physical switch. In this embodiment, the sensor is arranged to detect the second hand performing a predetermined gesture as a command to enable display object control mode, and detect the second hand ceasing to perform the gesture as a command to disable display object control mode.

### BRIEF DESCRIPTION OF THE SEVERAL VIEWS OF THE DRAWING

FIG. 1 is a block diagram of the present computer display object controller connected to a computer system.

FIG. 2 is a perspective view of the present computer display object controller embodied as an accessory to the computer system.

FIG. 3 is a perspective view of the computer display object controller embodied as an integral part of a notebook computer.

FIG. 4 is a perspective view of the computer display object controller embodied as an integral part of a keyboard.

FIG. 5 shows the computer display object controller of FIG. 4 in typing mode.

FIG. 6 shows the computer display object controller of FIG. 4 in hand motion control mode.

### DETAILED DESCRIPTION OF THE INVENTION

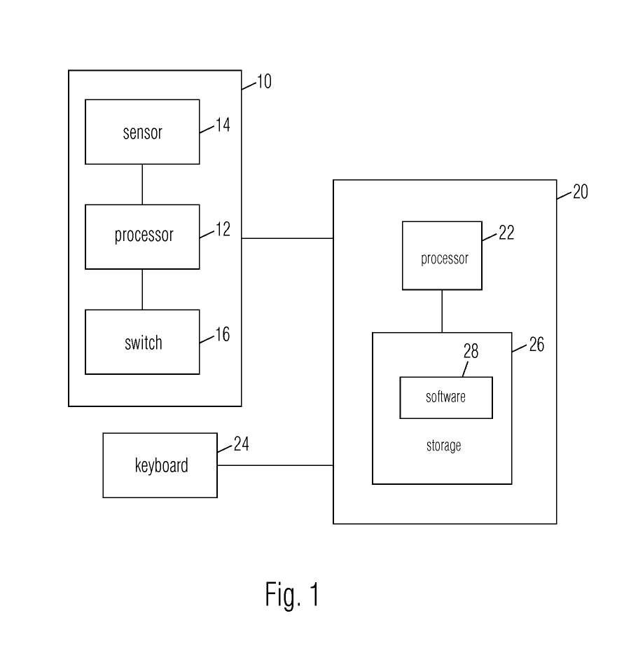

As shown in FIG. 1, a preferred embodiment of a computer display object controller 10 includes a processor 12, a sensor 14 and a switch 16 for connecting to a computer system 20 with a processor 22, a keyboard 24, storage 26 and software 28. Processor 12, sensor 14 and software 28 may be any technology well known in the art for tracking hand motion and controlling computer display objects, such as the technology used in the motion controller trademarked LEAP MOTION CONTROLLER sold by Leap Motion in San Francisco, Calif., or the motion controller trademarked KINECT sold by Microsoft in Redmond, Washington. Sensor 14 may include a light source and a camera, or other means well known in the art for detecting hand movements. Switch 16 is preferably a touch sensitive switch that responds to a light touch, but it may be a mechanical switch that must be pressed down. When switch 16 is touched or not touched, processor 12 is arranged to enable or disable motion control, respectively. Keyboard 24 is preferably a mechanical keyboard with movable keys for positive feedback.

Display object controller 10 includes a temporary operating mode and a toggle mode. In temporary mode, processor 12 is arranged to enable motion control when switch 16 is touched, and disable motion control when switch 16 is not touched. Toggle mode may be entered with another command, for example, by tapping switch 16 twice in quick succession. Toggle mode may be disabled by tapping switch 16 twice in quick succession again. Other methods or an additional toggle mode switch may be provided to enter or release toggle mode.

Alternatively, mode switching may be performed by additional instructions in software 28. When switch 16 is engaged, sensor 14 remains active but processor 12 is arranged to send a command to computer system 20 to disable display object control via software 28.

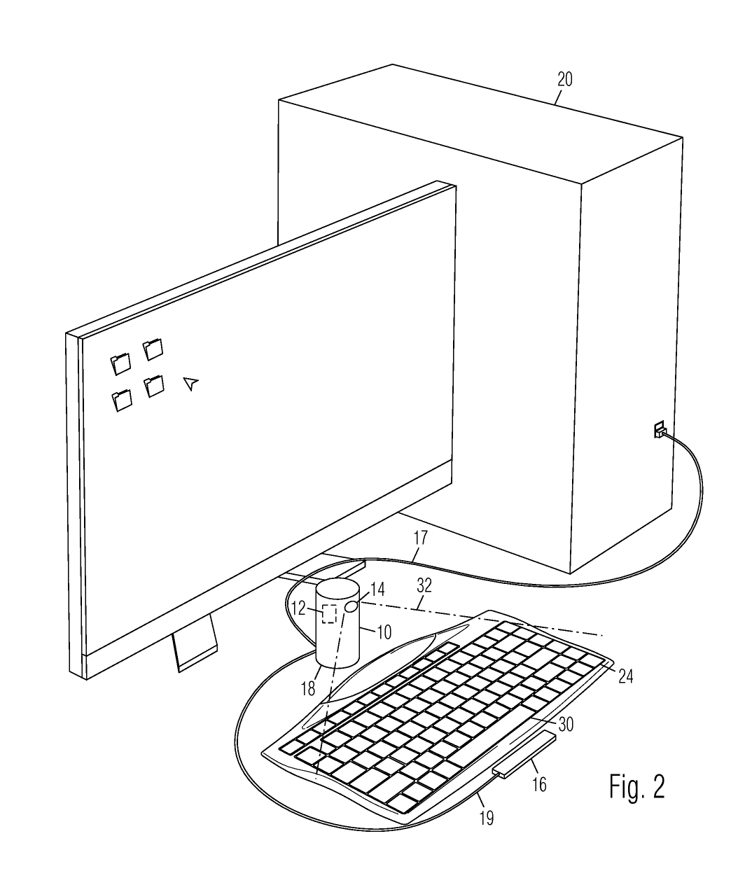

FIG. 2 shows controller 10 embodied as an add-on accessory for computer system 20. Processor 12 and sensor 14 are in a housing 18 connected to computer system 20 by a cable 17 and positioned behind keyboard 24. Switch 16 is connected to housing 18 by a cable 19 and positioned in front of keyboard 24, preferably adjacent a spacebar 30. Housing 18 is taller than keyboard 24 to elevate sensor 14 above keyboard 24. Sensor 14 is angled towards keyboard 24 and has a field of view 32 covering at least a portion of keyboard 24.

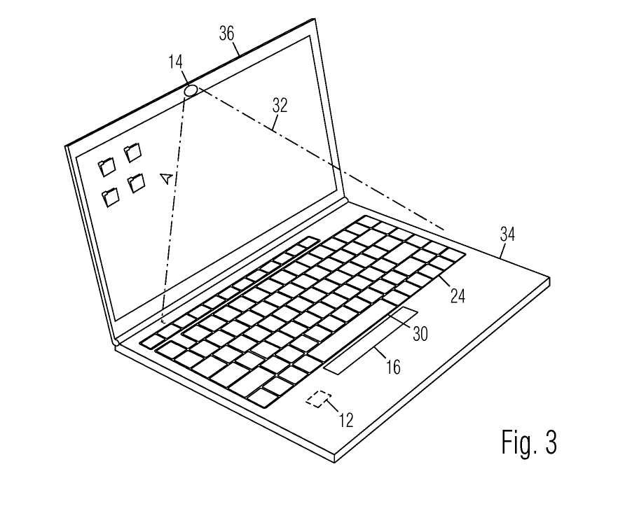

FIG. 3 shows the display object controller embodied as a built-in device in a notebook or all-in-one computer 34. Sensor 14 is positioned on an edge of a display 36 so that when the display is an operating position, it is elevated above keyboard 24 and has field of view 32 covering at least a portion of keyboard 24. Switch 16 is built into computer 34 immediately in front of spacebar 30, so it may be easily engaged by a thumb without the fingers of the hand moving away from the home keys of the keyboard. Processor 12 may be a dedicated circuit for motion control or it may be the CPU of computer 34.

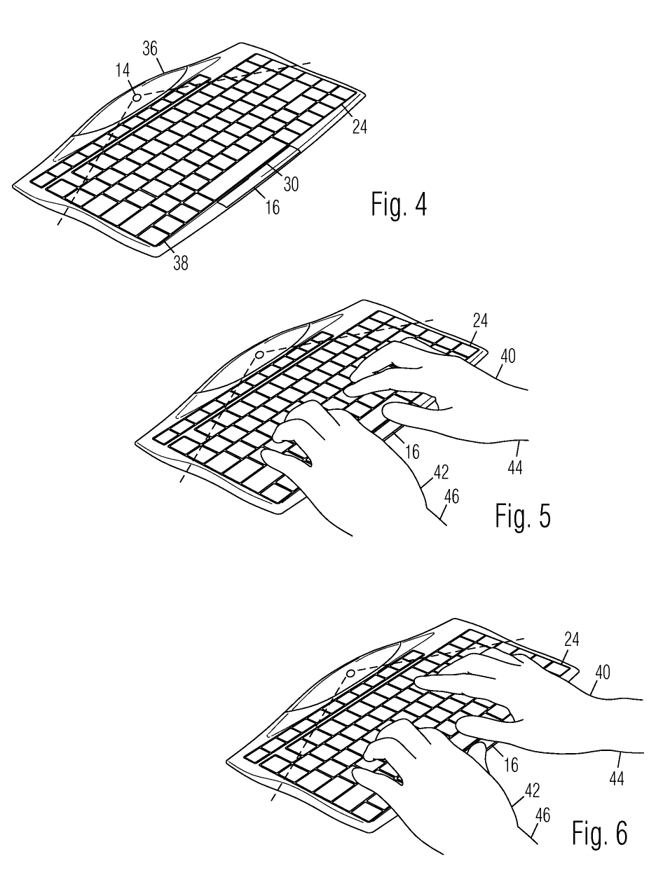

FIG. 4 shows the display object controller embodied as an integral part of keyboard 24. Sensor 14 is mounted in an upward projecting part 36 at the back of keyboard 24, so that sensor 14 is elevated above keys 38 of keyboard 24. Switch 16 is integrated into the front of keyboard 24 immediately adjacent spacebar 30. Switch 16 may be engaged by a thumb without the fingers of the hand moving away from the home keys of the keyboard.

FIGS. 5-6 show the operation of the display object controller with the embodiment of FIG. 4 as an example. In FIG. 5, the fingers of a first hand 40 and a second hand 42 are typing on keyboard 24. Either the right or left hand may be the first hand. The thumbs are disengaged from switch 16 so that display object control is disabled, and the typing motions of the hands are not misinterpreted as display object control motions. In FIG. 6, the user stops typing and touches the thumb of second hand 42 on switch 16 to enable display object control. The user raises the fingers of first hand 40 slightly above keyboard 24 and moves the fingers to control display objects. Since sensor 14 is angled towards the keyboard, the hands may remain in close proximity to and directly over the keyboard and still be in the sensor's field of view. When the user wants to cease display object control and resume typing, the user releases the thumb of second hand 42 from switch 16 to disable display object control. Arm 44 of first hand 40 and arm 46 of second hand 42 may generally remain in the same positions whether typing or controlling display objects. There is no need to lift the arm from the typing position to control display objects, so that fatigue is minimized. This is a significant advantage over prior art motion control devices.

In another embodiment, a switching means is provided as additional instructions in software 28 instead of a touch or mechanical switch 16. Sensor 14 is configured to sense the motion of both hands. The software is arranged to detect a predetermined gesture by the second hand as a command to enable display object control mode, and disable display object control mode when the hand ceases to perform the gesture. The gesture is preferably unusual enough so that the second hand is unlikely to unintentionally perform the gesture while typing or resting, but still easily performed without straining or fatigue. An example of such a gesture may be touching the thumb and index finger together, which is unlikely to happen unintentionally yet may be performed with ease. I claim:

1. A computer display object controller, comprising:
a sensor for being directed toward a keyboard for sensing movement of a first hand in the air directly over and in close proximity to the keyboard;
switching means responsive to operation by a second hand; and
a processor connected to the sensor and the switching means;
wherein when the switching means is operated by the second hand, the processor is responsive to the sensor for communicating with a computer system to control display objects by movement of the first hand in the air directly over and in close proximity to the keyboard; and
when the switching means is ceased to be operated by the second hand, the processor is arranged for communicating with the computer system to disable controlling the display objects by the movement of the first hand, so that the first hand may type on the keyboard.

2. The computer display object controller of claim 1, wherein the switching means comprises a touch switch for being positioned at a front of the keyboard.

3. The computer display object controller of claim 1, wherein the switching means comprises a method, which comprises sensing the second hand performing a predetermined gesture.

4. A computer display object controller, comprising:
a keyboard with keys;
a sensor at a rear of the keyboard elevated above the keys and directed towards the keys for sensing movement of a first hand in the air directly over and in close proximity to the keys;
switching means responsive to operation by a second hand; and
a processor connected to the sensor and the switching means;
wherein when the switching means is operated by the second hand, the processor is responsive to the sensor for communicating with a computer system to control display objects by movement of the first hand in the air directly over the keyboard while the arm of the first hand remains in a typing position; and
when the switching means is ceased to be operated by the second hand, the processor is arranged for communicating with the computer system to disable controlling the display objects by the movement of the first hand, so that the first hand may type on the keyboard.

5. The computer display object controller of claim 4, wherein the switching means comprises a touch switch at a front of the keyboard.

6. The computer display object controller of claim 4, wherein the switching means comprises a method, which comprises sensing the second hand performing a predetermined gesture.

7. A computer display object controller, comprising:
a keyboard with keys;
a computer display;
a sensor mounted on the computer display in an elevated position above the keyboard and directed towards the keys for sensing movement of a first hand in the air directly over and in close proximity to the keys;
switching means responsive to operation by a second hand; and
a processor connected to the sensor and the switching means;
wherein when the switching means is operated by the second hand, the processor is responsive to the sensor for communicating with a computer system to control display objects by movement of the first hand in the air directly over the keyboard while the arm of the first hand remains in a typing position; and
when the switching means is ceased to be operated by the second hand, the processor is arranged for communicating with the computer system to disable controlling the display objects by the movement of the first hand, so that the first hand may type on the keyboard.

8. The computer display object controller of claim 7, wherein the switching means comprises a touch switch at a front of the keyboard.

9. The computer display object controller of claim 7, wherein the switching means comprises a method, which comprises sensing the second hand performing a predetermined gesture.
